(19) United States
(12) Patent Application Publication
(10) Pub. No.: US 2007/0117539 A1
(43) Pub. Date: May 24, 2007

(54) Notification of a received message in a wireless mobile communication device based upon authentication

(75) Inventor: Ian Harris, Devizes (GB)

Correspondence Address: RESEARCH IN MOTION, LTD, 102 DECKER CT., SUITE 180, IRVING, TX, 75062, US

(73) Assignee: Research In Motion Limited

(21) Appl. No.: 11/286,629

(22) Filed: Nov. 23, 2005

(51) Int. Cl. H04M 1/66

(52) U.S. Cl. 455/411

(57) ABSTRACT

A method (200) and an apparatus (300) for a wireless mobile communication device (102) registered in a wireless communication network (100) for providing a notification of an authenticated received message are provided. The mobile device (102) receives a message having a predefined characteristic (202), evaluates authenticity of the received message based upon the predefined characteristic (204), and providing a notification of the received message if the received message is authenticated (212). The mobile device (102) also overrides a local notification setting (210), which allows a delay notification of the received message, to immediately provide a notification of the received message upon authenticating the received message.

### FIELD OF THE INVENTION

The present invention generally relates to mobile communication, and more specifically to a method and an apparatus for providing a notification of a received message based upon authentication of the received message in a wireless mobile communication device.

### BACKGROUND OF THE INVENTION

In today's wireless mobile communication systems, a user of a mobile wireless communication device can often communicate by sending and receiving Short Messages through Short Message Service (“SMS”). For certain types of wireless mobile communication devices, such messaging services as Cell Broadcast Service (“CBS”) and Multimedia Messaging Service (“MMS”) may also be available. In case of a national emergency or local emergency such as a hurricane or tornado, the above mentioned messaging services may be employed by an appropriate authority to reach and notify the affected public having such wireless devices. At the same time, for the wireless device users, there is a risk of receiving falsified emergency messages or simply unwanted messages such as spam messages.

### BRIEF DESCRIPTION OF THE DRAWINGS

FIG. 1 is an exemplary block diagram of a wireless communication network in which a wireless mobile communication device in accordance with at least one of the preferred embodiments may be practiced;

FIG. 2 is an exemplary flowchart illustrating the process in a wireless mobile communication device for providing a notification of a received message in accordance with at least one of the preferred embodiments;

FIG. 3 is an exemplary block diagram of a wireless mobile communication device configured to provide a notification of an authenticated received message in accordance with at least one of the preferred embodiments; and

FIG. 4 is an exemplary flowchart illustrating the process in a wireless communication network for providing a notification to a wireless mobile communication device of a received message in accordance with at least one of the preferred embodiments.

### DETAIL DESCRIPTION OF THE PREFERRED EMBODIMENTS

A wireless mobile communication device receives a message, which is designed to reach as many subscribers as possible in a targeted area. The message may be urgent in nature, such as a natural disaster in the targeted area or other emergency situations which the general public in the vicinity needs to be made aware of. Such an emergency message may be provided through messaging services such as the Short Message Services (“SMS”), Cell Broadcast Service (“CBS”) and Multimedia Messaging Service (“MMS”). To avoid notifying the user of the wireless mobile communication device if the message is falsified or a spam, the wireless mobile communication device evaluates the authenticity of the received message. If the received message is authenticated, then the wireless mobile communication device provides a notification that an urgent message has been received. Although a mechanism, known as Message Class zero, exists in SMS and CBS specifications to indicate to the wireless mobile communication device that a particular received short message should be displayed immediately, the user of the mobile device can override the Message Class Zero setting, allowing the mobile device not to have such messages displayed immediately. To provide an immediate notification of an emergency message, the wireless mobile communication device may override the user setting to provide an immediate notification upon authenticating the received message.

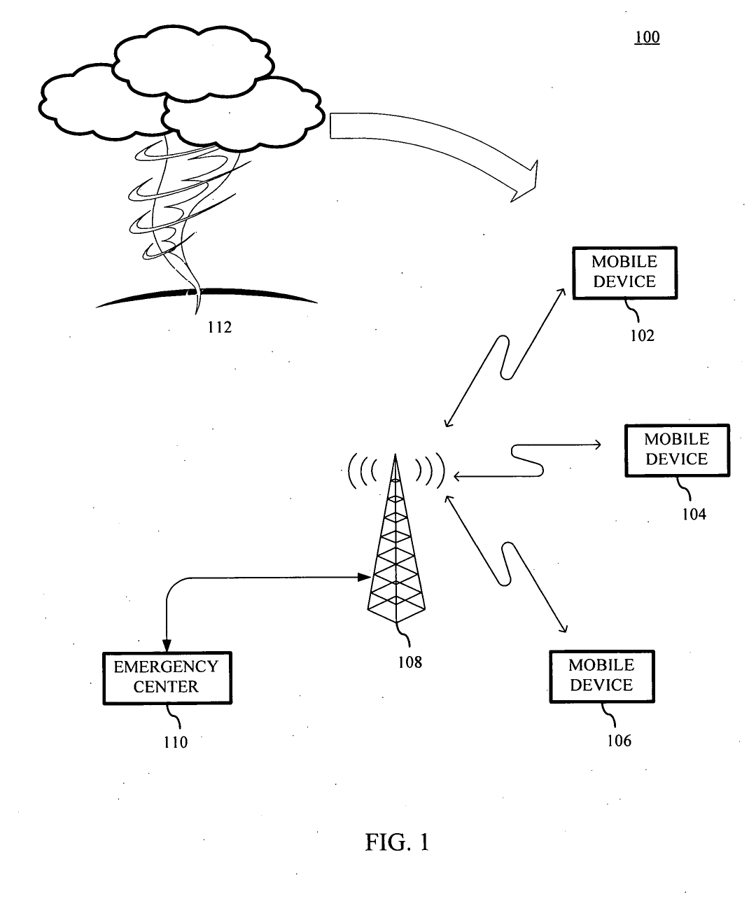

FIG. 1 is an exemplary block diagram of a wireless communication network 100 in which a wireless mobile communication device (“mobile device”) 102 in accordance with at least one of the preferred embodiments may be practiced. The wireless communication network 100 is shown to have a plurality of mobile devices (three mobile devices 102, 104, and 106 are shown for simplicity), which are capable of wirelessly communicating with a fixed base station 108. The fixed base station 108 is connected to an emergency center 110, such as police, fire department, local government, or any agency having authority to provide a wide area notification of situations of the public concern such as a tornado 112 approaching the mobile devices 102, 104, and 106.

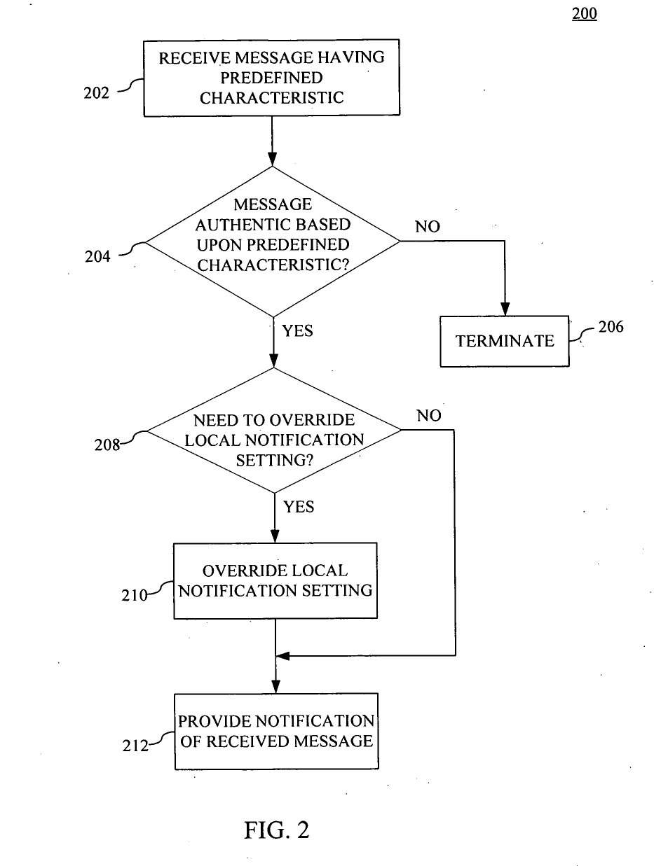

FIG. 2 is an exemplary flowchart 200 illustrating the process in the mobile device 102 for providing a notification of a received message in accordance with at least one of the preferred embodiments. In block 202, the mobile device 102, which is registered in the wireless communication network 100, receives a message having a predefined characteristic. The predefined characteristic may be a digital signature provided by the message originator, a predefined bit set by the message originator, or any other mechanism that can be used by the mobile device 102 to determine the authenticity of the message. The message may be urgent in nature, such as a warning of the tornado 112 approaching, requiring an immediate attention of the user of the mobile device 102, and may be a CBS message, a MMS message, an SMS message, or any message that is configured to reach a plurality of mobile devices registered in the wireless communication network 100. To avoid notifying the user of the mobile device 102 of falsified or spam type of unauthorized messages, the mobile device 102 evaluates authenticity of the received message based upon the predefined characteristic in block 204. If the mobile device 102 is unable to authenticate the received message in block 204, meaning that the received message originated from a source unauthorized to utilize such a wide transmission method, then the process terminates in block 206. However, if the received message is authenticated in block 204, meaning that the urgency of the received message is genuine, the mobile device 102 determines in block 208 whether a local notification setting, such as the Message Class Zero setting, of the mobile device 102 needs to be overridden in order to provide an immediate notification of the received message. If the local notification setting needs to be overridden, the mobile device 102 overrides the local notification setting in block 210, and provides an immediate notification of the authenticated received message in block 212. If the local notification setting is determined not needing to be overridden, the mobile device 102 provides an immediate notification of the authenticated received message in block 212. The notification of the received message provided by the mobile device 102 may be any one of various types of notifications including a visual notification such as an indicator light turning on or flashing, an audible notification such as an alert being activated, a motional notification such as the mobile device 102 vibrating, and the displaying of the authenticated received message.

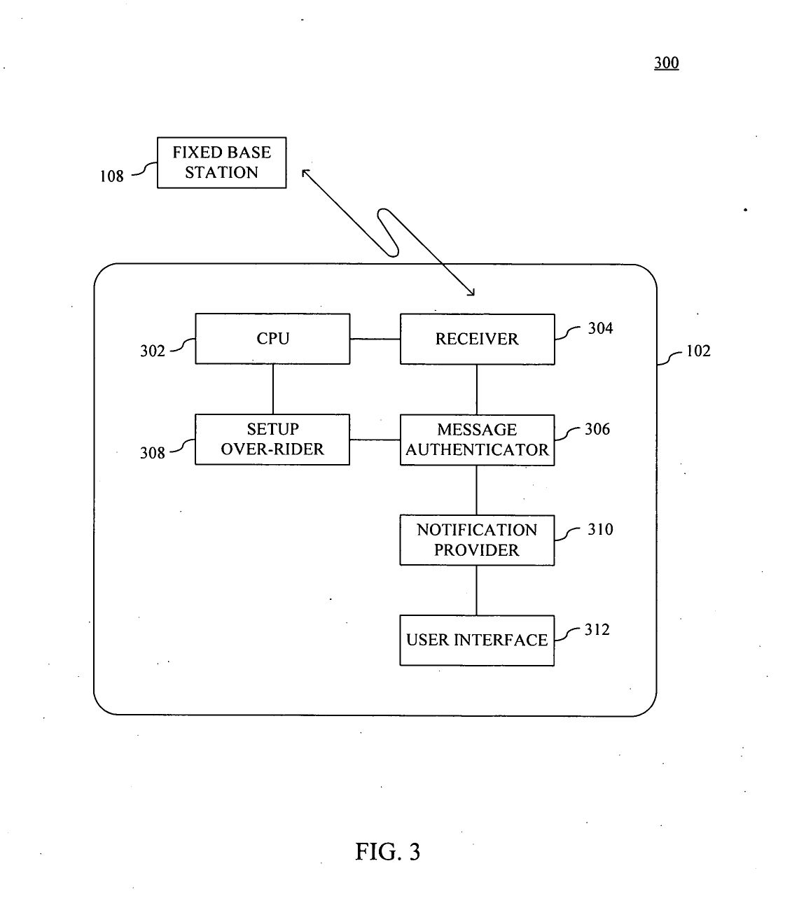

FIG. 3 is an exemplary block diagram 300 of the mobile device 102 configured to provide a notification of an authenticated received message in accordance with at least one of the preferred embodiments. The mobile device 102 has a central processing unit (“CPU”) 302, which is configured to control overall functionality of the mobile device 102, including a local notification setting of the mobile device 102 such as the Message Class Zero setting, which allows a delayed notification of the received message. A receiver 304 is coupled to the CPU 302, and is configured to receive a message having a predefined characteristic from the fixed base station 108. A message authenticator 306 is coupled to the receiver 304, and is configured to evaluate authenticity of the received message based upon the predefined characteristic. As previously described, the predefined characteristic may be any mechanism that can be used by the mobile device 102 to determine the authenticity of the message, and the message may be urgent in nature requiring an immediate attention of the user of the mobile device 102, and may be any message that is configured to reach a plurality of mobile devices registered in the wireless communication network 100. A setup over-rider 308 is coupled to the CPU 302 and. the message authenticator 306, and is configured to override the local notification setting of the mobile device 102 if the received message is authenticated. A notification provider 310 is coupled to the message authenticator 306, and is configured to provide a notification of the received message if the received message is authenticated. By overriding the local notification setting by the setup over-rider 308, the notification provider 310 is capable of immediately providing the notification of the received message upon the authentication of the received message. The notification of the received message provided by the notification provider 310 in the mobile device 102 may be any one of various types of notifications including a visual notification such as an indicator light turning on or flashing, an audible notification such as an alert being activated, a motional notification such as the mobile device 102 vibrating, and the displaying of the authenticated received message.

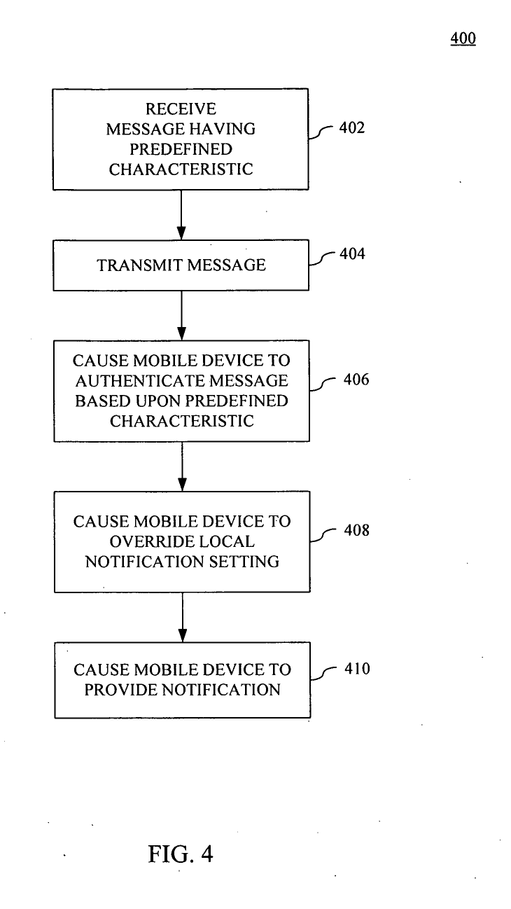

FIG. 4 is an exemplary flowchart 400 illustrating the process in the wireless communication network 100 for providing a notification to the mobile device 102 of a received message in accordance with at least one of the preferred embodiments. In block 402, the wireless communication network 100 receives a message having a predefined characteristic, which provides authenticity of the message, from the emergency center 110. The emergency center 110 may be police, fire department, local government, or any agency having authority to provide a wide area notification of situations of the public concern such as a tornado 112 approaching the mobile devices 102, 104, and 106. The message may be a CBS message, a MMS message, an SMS message, or any message that is configured to reach a plurality of mobile devices registered in the wireless communication network 100. In block 404, the wireless communication network 100 transmits the message through the fixed base station 108. The message causes the mobile device 102, which receives the message, to authenticate the message based upon the predefined characteristic in block 406. In block 408, the message further causes the mobile device 102 to override a local notification setting, such as the Message Class Zero setting, upon authenticating the message, and causes the mobile device 102 to immediately provide a notification of the message upon authenticating the message in block 410. The notification of the message may be any one of various types of notifications including a visual notification such as an indicator light turning on or flashing, an audible notification such as an alert being activated, a motional notification such as the mobile device 102 vibrating, and the displaying of the authenticated received message.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a wireless mobile communication device registered in a wireless communication network for providing a notification of a received message, the method comprising:
receiving a message having a predefined characteristic;
evaluating authenticity of the received message based upon the predefined characteristic; and
if the received message is authenticated, providing a notification of the received message.

2. The method of claim 1, wherein the message is at least one of:
a Cell Broadcast Service message,
a Multimedia Messaging Service message,
a Short Message Service message, and
a message configured to reach a plurality of wireless mobile communication devices registered in the wireless communication network.

3. The method of claim 2, wherein the predefined characteristic includes at least one of:
a digital signature provided by an originator of the message, and
a predefined bit included in the received message.

4. The method of claim 3, further comprising:
overriding a local notification setting of the wireless mobile communication device if the received message is authenticated.

5. The method of claim 4, wherein providing the notification of the received message includes:
immediately providing the notification of the received message upon authenticating the received message.

6. The method of claim 5, wherein providing the notification of the received message includes at least one of:
providing a visual notification,
providing an audible notification,
providing a motional notification, and
displaying the authenticated message.

7. A wireless mobile communication device configured to provide a notification of a received message, the wireless mobile communication device comprising:
a receiver configured to receive a message having a predefined characteristic;
a message authenticator coupled to the receiver, the message authenticator configured to evaluate authenticity of the received message based upon the predefined characteristic; and
a notification provider coupled to the message authenticator, the notification provider configured to provide a notification of the received message if the received message is authenticated.

8. The wireless mobile communication device of claim 7, wherein the message is at least one of:
a Cell Broadcast Service message,
a Multimedia Messaging Service message,
a Short Message Service message, and
a message configured to reach a plurality of wireless mobile communication devices registered in the wireless communication network.

9. The wireless mobile communication device of claim 8, wherein the predefined characteristic includes at least one of:
a digital signature provided by an originator of the message, and
a predefined bit included in the received message.

10. The wireless mobile communication device of claim 9, further comprising:
a setup over-rider coupled to the message authenticator, the setup over-rider configured to override a local notification setting of the wireless mobile communication device if the received message is authenticated.

11. The wireless mobile communication device of claim 10, wherein the notification provider is further configured to immediately provide the notification of the received message upon the authentication of the received message.

12. The wireless mobile communication device of claim 11, wherein the immediate notification of the received message includes at least one of:
a visual notification,
an audible notification,
a motional notification, and
the authenticated message displayed on a display of the wireless mobile communication device.

13. A method in a wireless communication network for providing a notification to a wireless mobile communication device of a received message, the method comprising:
receiving a message having a predefined characteristic, the predefined characteristic providing authenticity of the message;
transmitting the message;
causing a wireless mobile communication device receiving the message to authenticate the message based upon the predefined characteristic; and
causing the wireless mobile communication device to immediately provide a notification of the message upon authenticating the message.

14. The method of claim 13, wherein the message is at least one of:
a Cell Broadcast Service message,
a Multimedia Messaging Service message,
a Short Message Service message, and
a message configured to reach a plurality of wireless mobile communication devices registered in the wireless communication network.

15. The method of claim 14, wherein the predefined characteristic includes at least one of:
a digital signature provided by an originator of the message, and
a predefined bit included in the transmitted message.

16. The method of claim 15, further comprising:
causing the wireless mobile communication device to override a local notification setting of the wireless mobile communication device before causing the wireless mobile communication device to immediately provide a notification of the message upon authenticating the message.

17. The method of claim 16, wherein the immediate notification of the message upon authenticating the message includes at least one of:
a visual notification,
an audible notification,
a motional notification, and
the authenticated message displayed on a display of the wireless mobile communication device.
